(19) United States
(12) Patent Application Publication
(10) Pub. No.: US 2016/0063274 A1
(43) Pub. Date: Mar. 3, 2016

(54) Data Processing Device with Light Indicator Unit

(71) Applicant: Steven E. Martin, Cape Coral, FL (US)

(72) Inventor: Steven E. Martin, Cape Coral, FL (US)

(21) Appl. No.: 14/472,973

(22) Filed: Aug. 29, 2014

(51) Int. Cl. G06F 21/62; H04N 5/225; G06F 21/32; H04N 5/232

(52) U.S. Cl. CPC G06F 21/6245; H04N 5/23206; H04N 5/2256; H04N 5/23229; G06F 21/32

(57) ABSTRACT

This invention comprises an image and audio data processing device that comprises a transceiver to send and receive image and audio data over a network, a camera module which captures and processes image and/or audio data individually or in combination when a user activates the camera module, a camera module sensor which identifies a use operation of capturing the image and audio data, and an indicator unit which includes a light emitting module. When the camera module is capturing and processing the image and audio data and the transceiver sends and receives said data over the network, the camera module sensor identifies the use operation and activates the indicator unit thereby illuminating the light emitting module.

### FIELD OF THE INVENTION

The present invention relates to a data capture and processing device that receives image data and audio data, and has a module which activates a light indicator unit when the device is capturing and processing image data and audio data.

### BACKGROUND OF THE INVENTION

A data capture and processing device is an input/output device may generally receive and transmit data in a visual, sensory and/or tactile form. When the input information is supplied as an electrical signal, the display is called an electronic display. When input information is supplied as an image data and/or audio data signal, a device may not only display but process and transform said captured data, into a format that may be easily transmitted through a network connection. Common applications for electronic devices such as this are televisions, computer monitors, and mobile phones. These devices may be used in a number of fields and vary in shape and size.

### SUMMARY OF THE INVENTION

It is, therefore, an object of the present invention to provide a light emitting indicator unit which is an integral part of an image data and audio data capture and processing device. It is another object of the present invention to provide a system of which said image data and audio data capture device is one component. Furthermore, a computer readable storage medium containing non-transitory computer executable instructions to operate said image data and audio data capture device as part of the said system is also provided.

An exemplary environment for the present invention can include, but is not limited to, use by an individual person, for example, a person using the camera feature on a tablet, smart phone or other mobile device. The present invention is also contemplated to be used in any other environment in which display and interaction on a computing device is desired, for example, as part of business operation, on a home computer network to identify when minors are using said devices, or any other environment when notification of use an image data and audio data capture device is necessary.

In one exemplary embodiment of the present invention, an image data and an audio data capture and processing device is provided. Said device comprises a transceiver, a camera module, a camera module sensor, and an indicator unit.

In one exemplary aspect of the present invention, the transceiver is configured to send and receive image data and audio data over a network.

In another exemplary aspect of the present embodiment, the camera module is configured to capture and process the image data and the audio data, individually or in combination, when a user activates the camera module.

In a further exemplary aspect of the present embodiment, the camera module sensor is configured to identify a use operation of capturing the image data and the audio data.

In yet a further exemplary aspect of the present embodiment, the indicator unit includes a light emitting module.

Furthermore, in an additional exemplary aspect of the present embodiment, when the camera module is capturing and processing the image data and the audio data, and the transceiver sends and receives said data over the network, the camera module sensor is configured to identify the use operation and activate the indicator unit, illuminating the light emitting module.

The following are additional and/or exemplary aspects of the exemplary image data and an audio data capture and processing device as described above, one or more of which can be combined with the basic invention as embodied above:
the camera module can be configured to further comprise at least one photodiode to convert received light into said image data;
the camera module can be configured to further comprise at least one transducer to convert received sound into said audio data;
the camera module sensor can be configured to further comprise a processor and computer executable instructions, which when executed by the processor, cause the camera module sensor to authenticate image data and audio data sent and received via the transceiver to determine if a privacy invasive software is simulating an authenticated user of the image data and audio data processing device and retrieving said image data and said audio data;
the camera module sensor can be configured to further comprise computer executable instructions, which when executed by the processor, cause the camera module sensor to flag for notification the privacy invasive software and transmitting the notification to the authenticated user of the image data and audio data processing device;
the light emitting module of the indicator unit can be configured to further comprise at least one light emitting diode; and
the light emitting module of the indicator unit can be configured to further comprise a first emitting element which is activated by the camera module sensor when the use operation of the camera module is identified and can be configured to further comprise a second light emitting element which is activated by the camera module sensor when a privacy invasive software is simulating an authenticated user of the image data and audio data processing device and retrieving said image data and said audio data.

In another exemplary embodiment of the present invention, a computer-operated image data and an audio data retrieving device is provided. Said device comprises a transceiver, a processor, a camera module, a camera module sensor, and an indicator unit.

In one exemplary aspect of the present embodiment, the transceiver can be configured to send and receive image data and audio data over a network.

In another exemplary aspect of the present embodiment, the processor can be configured to process image data and audio data.

In yet another exemplary aspect of the present embodiment, the camera module can be configured to capture and process the image data and the audio data, individually or in combination, when an authenticated user activates the camera module.

In yet another exemplary aspect of the present embodiment, the camera module sensor can be configured to identify a use operation of capturing the image data and the audio data and can be configured computer executable instructions, when executed by the processor, to cause the camera module sensor to:

authenticate image data and audio data sent and received via the transceiver to determine if a privacy invasive software is simulating an authenticated user of the computer-operated image data and an audio data retrieving device and recovering the image data and the audio data;

flag for notification the privacy invasive software; and

transmit the notification to the authenticated user of the computer-operated image data and an audio data retrieving device.

In yet still another exemplary aspect of the present embodiment, the indicator unit can be configured to include. a light emitting module.

In yet another exemplary aspect of the present embodiment, the camera module can be configured to capture the image data and the audio data, and when the transceiver sends and receives said data over the network, the camera module can be configured to identify the use operation and cause the processor to execute the computer readable instructions, and thereafter activate the indicator unit, illuminating the light emitting module.

The following are additional and/or exemplary aspects of the computer-operated image data and an audio data retrieving device as described above, one or more of which can be combined with the basic invention as embodied above:
the camera module can be configured to further comprise at least one photodiode to convert received light into said image data;
the camera module can be configured to further comprise at least one transducer convert received sound into said audio data;
the light emitting module of the indicator unit can be configured to further comprise at least one light emitting diode; and
the light emitting module of the indicator unit can be configured to further comprise a first emitting element, which is activated by the camera module sensor when the use operation of the camera module is identified, and can be configured to further comprise a second light emitting element, which is activated when by the camera module sensor when a privacy invasive software is simulating an authenticated user of the image data and audio data processing device and retrieving said image data and said audio data.

Another exemplary embodiment of the present invention comprises a non-transitory computer readable storage medium having computer executable instructions, the computer executable instructions when installed onto a computing device enable the computing device to perform actions.

In one exemplary aspect of the present embodiment, the computer executable instructions when installed onto a computing device can enable the computing device to detect an image data stream or an audio data stream being provided to a camera module of the computing device by a user.

In another exemplary aspect of the present embodiment, the computer executable instructions when installed onto a computing device can enable the computing device to authenticate the user providing the image data stream or the audio data stream to the camera module of the computing device.

In yet another exemplary aspect of the present embodiment, the computer executable instructions when installed onto a computing device can enable the computing device to monitor a transceiving channel of the computing device, to determine if a privacy invasive software is simulating an authenticated user of the camera module via a remote network device and removing to the remote network device the image data stream and the audio data stream.

In a further exemplary aspect of the present embodiment, the computer executable instructions when installed onto a computing device can enable the computing device to flag for notification the privacy invasive software;

In yet a further exemplary aspect of the present embodiment, the computer executable instructions when installed onto a computing device can enable the computing device to transmit the notification to the authenticated user; and

In yet still a further exemplary aspect of the present embodiment; the computer executable instructions when installed onto a computing device can enable the computing device to activate an indicator unit which further comprises a light emitting module.

The following are additional and/or exemplary aspects of the exemplary computer executable instructions as described above, one or more of which can be combined with the basic invention as embodied above:
the camera module can be configured to further comprise at least one photodiode to convert received light into the image data stream and at least one transducer to convert received sound into the audio data stream;
the light emitting module of the indicator unit can be configured to further comprise at least one light emitting diode; and
the light emitting module of the indicator unit can be configured to further comprise a first emitting element which is activated by the camera module sensor when the use operation of the camera module is identified, and can be configured to further comprise a second light emitting element which is activated when by the camera module sensor when a privacy invasive software is simulating an authenticated user of the image data and audio data processing device and retrieving said image data and said audio data.

An exemplary method of using and/or operating any of the above-described device embodiments is further provided.

One exemplary aspect of the present method comprises activating a camera module which captures and processes an image data stream or an audio data stream when a user initiates said activation.

Another exemplary aspect of the present method comprises identifying via a camera module sensor the capturing and processing of the image data stream and the audio data stream.

Yet another exemplary aspect of the present method comprises illuminating a light emitting module of an indicator unit when the camera module sensor identifies the use operation and activates the indicator unit thereby illuminating the light emitting module.

The following are additional and/or exemplary aspects of the exemplary method as described above, one or more of which can be combined with the basic invention as embodied above:
the camera module can be configured to further comprise at least one photodiode to convert received light into the image data and the at least one transducer to convert received sound into the audio data;
the camera module sensor can be configured to further comprise computer executable instructions, which when executed by a processor, cause the camera module sensor to authenticate the image data stream and the audio data stream to determine if a privacy invasive software is simulating an authenticated user a device, and retrieving the image data stream and the audio data stream;
the camera module sensor can be configured to further comprise computer executable instructions, which when executed by the processor, cause the camera module sensor to flag for notification the privacy invasive software and transmitting the notification to the authenticated user of the image data and audio data processing device;
the light emitting module of the indicator unit can be configured to further comprise a first emitting element which can be activated by the camera module sensor when the use operation of the camera module is identified, and can be configured to further comprise a second light emitting element, which can be activated by the camera module sensor when a privacy invasive software is simulating an authenticated user of the image data and audio data processing device and retrieving the image data and the audio data; and
the light emitting module of the indicator unit can be configured to further comprise at least one light emitting diode.

These and other exemplary aspects of the present invention are described herein below. Those skilled in the art will recognize still other aspects of the present invention upon reading and understanding the attached description.

### BRIEF DESCRIPTION OF THE DRAWINGS

The present invention is illustrated by way of example, and not in limitation, in the figures of the accompanying drawings. For a better understanding of the present invention and its embodiments, reference will be made to the following detailed description, which is to be read in association with the accompanying drawings.

FIG. 1 illustrates a circuit diagram of one embodiment of the inventive concept, an image data and audio data capture and processing device with a light indicator unit.

FIG. 2 illustrates one exemplary embodiment of the inventive concept, embodied in a mobile communication device.

FIG. 3 illustrates another exemplary embodiment of the inventive concept, embodied in a camera module integrated into a laptop computing device.

FIG. 4 illustrates another exemplary embodiment of the inventive concept, embodied in an external webcam module attached to a desktop computing device.

FIG. 5 illustrates a logical flow diagram generally showing one embodiment of a process of computer readable instructions which operate an image data and audio data capture and processing device of the inventive concept.

FIG. 6 illustrates a block diagram generally showing one method of using and/or operating any of the embodiments as described above of the inventive concept.

### DETAILED DESCRIPTION OF THE INVENTION

The present invention will now be described more fully herein after with reference to the accompanying drawings, which form a part hereof, and which show, by way of illustration, specific exemplary embodiments by which the invention may be practiced. This invention may, however, be embodied in many different forms and should not be construed as limited to the exemplary embodiments set forth herein. Rather, these exemplary embodiments are provided so that this disclosure will be thorough and complete, and will fully convey the scope of the invention to those skilled in the art. Among other things, the present invention may be embodied as methods or devices. Accordingly, various exemplary embodiments may take the form of an entirely hardware embodiments, an entirely software embodiment and/or an embodiment combining software and hardware aspects. The following detailed description is, therefore, not to be taken in a limiting sense.

Throughout the specification and claims, the following terms take the meanings explicitly associated herein, unless the context clearly otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The following briefly describes the embodiments of the invention in order to provide a basic understanding of some aspects of the invention. This brief description is not intended as an extensive overview. It is not intended to identify key or critical elements, or to delineate or otherwise narrow the scope, its purpose is merely to present some concepts in a simplified form as a prelude to the more detailed description that is presented later.

The present invention, generally, is directed towards providing a light emitting indicator unit which is an element of an image data and audio data capture and processing device. In general, non-limiting terms, the present invention provides a lighted array or a flash mechanism which operates in a personal electronic device which has image capture and audio capture functionalities, when the image capture (i.e., a camera and/or video feature of the device) feature is in use, by either an intended user or an unintended user. An exemplary purpose of the light indicator unit is to provide a notification to a user of the device, where the notification cannot be altered and/or removed by means of a malicious or security invasive software application.

An exemplary environment for the present invention can include, but is not limited to, use by an individual person, for example, a person using the camera feature on a tablet, smart phone or other mobile device. The present invention is also contemplated to be used in any other environment in which display and interaction on a computing device is desired, for example, as part of business operation, on a home computer network to identify when minors are using said devices, or any other environment when notification of use an image data and audio data capture device is necessary.

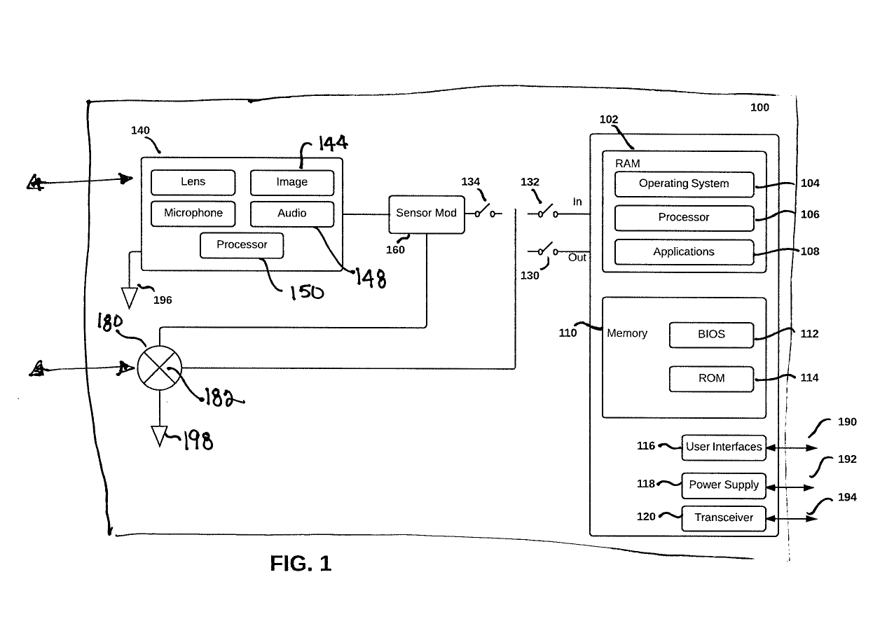

FIG. 1 illustrates a block diagram of one embodiment of the inventive concept, an image data and audio data capture and processing device 100 with a light indicator unit 180.

In one exemplary embodiment of the present invention, an image data and an audio data capture and processing device 100 is provided. This device comprises a number of elements, including but not limited to a camera module 140, a camera module sensor 160, and an indicator unit 180.

Device 100 further comprises interchangeable modules and elements, which may or may not be necessary for the optimal function of device 100. For example, all modules are not necessary for device 100 to operate, however beneficial to a user these modules may be. Also, all modules are replaceable with other, non-named modules, for the purpose of providing a functionally operational device 100, dependent upon the specific needs of the user. However, the components shown are sufficient to disclose an illustrative embodiment for practicing the invention.

As previously stated, the present invention relates to a light indicator unit which is an element of an image capture and audio capture and processing device 100. Said can encompass any number of electronic devices, but for illustrative purposes, may be generally directed towards those electronic devices which a user operates for the purpose of computing as well as other user-oriented features, for example, a mobile phone, an MP3 player, a laptop computer, a tablet, a desktop computer and the like. As such, the general and common elements of such devices are described herein without specificity, but more as a general overview of the common elements of such devices. A more detailed description of the inventive concept including the light indicator unit 180 and a camera module 160 are below.

Device 100 can optionally include a processing unit (CPU) which may be in communication with a mass memory via a bus or any other known or reasonably ascertainable communication method. Mass memory may optionally include a RAM, such as RAM 102, a generalized memory, such as memory 110, a ROM, such as ROM 114, and other storage means. A mass memory generally illustrates an example of at least one computer readable storage media (i.e., storage device) for storage of information such as computer readable instructions, data structures, program nodules or other data. A mass memory may also store a basic input/output system (“BIOS”), such as BIOS 112, for controlling low-level operation of a device 100. The mass memory may also store an operating system, such as operating system 104, for controlling the operations of a device 100. It will be appreciated that this component may include a general-purpose operating system such as a version of UNIX, or LINUX™, or a specialized client communication operating system such as Windows Mobile™ Android® operating system, or the Symbian® operating system. The operating system may include, or interface with Java virtual machine module that enables control of hardware components and/or operating systems operations via Java application programs.

A mass memory may further include one or more data storage locations, which can be utilized by a device 100 to store, among other things, applications and/or other data. For example, data storage may also be employed to store information that describes various capabilities of a device 100. The information may then be provided to another device 100 based on any of a variety of events, including being sent as part of a header during a communication, sent upon request, or the like. Data storage may also be employed to store sensor definition information, instructions and data matrices which may be used as part of a decision tree, or the like. Furthermore, at least a portion of the information may be stored on a disk drive or other computer-readable storage device internal to or external from a device 100.

Applications, such as applications 108, may include computer executable instructions which, when executed by device 100, may cause a camera module 140 and a camera module sensor 160 to authenticate image data and audio data to determine if a privacy invasive software is simulating an authenticated user of device 100, may cause a camera module 140 and a camera module sensor 160 to flag for notification the privacy invasive software and transmit the notification to an authorized and authenticated user; other device functions, for example, such as messages, audio, video, and enable telecommunication with another user of another client device. Other examples of application programs include calendars, search programs, email clients, IM applications, SMS applications, VOIP applications, contact managers, task managers, transcoders, database programs, word processing programs, security applications, spreadsheet programs, games, search programs, and so forth.

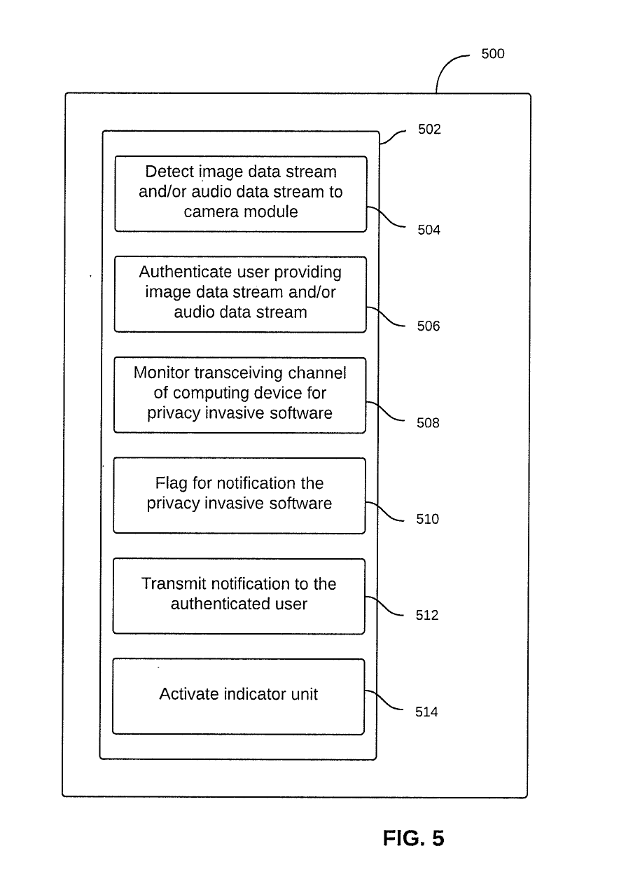

How application features described herein, specifically the computer executable instructions for how a camera module and camera module sensor operate in conjunction with a light indicator unit, and so such features, and how device 100 may be operatively instructed by a CPU to complete these and other application tasks, methodology of computer executable instructions, and other general functionality shall be described in greater detail below, in reference to FIG. 5.

Furthermore, applications, such as applications 108, may include, for example, imager(s), browser(s), and content manager(s) (CMs). Browsers may include virtually any application configured to receive and display graphics, text, multimedia, and the like, employing virtually any web based language. In one embodiment, the browser application is enabled to employ Handheld Device Markup Language (HDML), Wireless Markup Language (WML), WMLScript, JavaScript, Standard Generalized Markup Language (SMGL), HyperTest Markup Language (HTML), eXtensible Markup Language (XML), and the like, to display and send a message. However, any of a variety of other web-based languages may be employed.

In one embodiment, browser may be configured to enable access to a graphical user interface and/or CMs. In one embodiment, the user interface may be employed by a user of client device 100 to create image streams, create audio streams, receive image streams, receive audio streams, review and/or manage user preferences, and/or other aspects of creating, managing and storing image and audio data streams.

Client device 100 may also optionally include a power supply, such as power supply 118, one or more network interface(s), such as transceiver 120 which may engage in network communication 194, an input/output interface, such as user interface(s) 116, a display, an image, an audio interface, an illuminator, a keypad, other haptic interface(s), and an optional global positioning systems (GPS) receiver. Power supply 118 provides power to client device 100. A rechargeable or non-rechargeable battery may be used to provide power. The power may also be provided by an external power source, such as an AC adapter or a powered docking cradle that supplements and/or recharges a battery. Of these power provisions may result in a dissipate/charge signal 192.

A device, such as device 100, may optionally communicate with a number of other electronic devices, for example, a remote base station or directly with another computing device. Transceiver 120 may include circuitry for coupling a device 100 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UEB), IEEE 8022.16 Worldwide Interoperability for Microwave Access (WiMax), SIP/RTP, or any of a variety of other wireless communication protocols. Transceiver 120 is sometimes known as a network interface, transceiving device, or network interface card (NIC).

User interfaces 116 may also comprise input/output interface(s) for communicating with external devices, such as a headset, or other input or output devices. These interfaces can utilize one or more communication technologies, such as USB, infrared, Bluetooth™, or the like.

Display may be a liquid crystal display (LCD), gas plasma, light emitting diode (LED), or any other type of display used with a computing device. Display may also include a touch sensitive screen arranged to receive input from an object such as a stylus or a digit from a human hand.

An image interface can be arranged to produce and receive image data signals and streams, for example, pictures, video, and the like. For example, an image interface may include an image recording element, such as a camera, lens, video, or other image capture element. An image interface can also optionally include an image display element, for displaying an image created via an image recording element, such as camera module 140, or transmitted image data signals and/or streams sent to a device 100. An illuminator may provide a status indication and/or provide light. In one embodiment, an illuminator may remain active for specific periods of time or in response to events. For example, an illuminator may backlight buttons in various patterns when particular actions are performed, such as dialing another client device. An illuminator may also cause light sources positioned within a transparent or translucent case of a device to illuminate in response to actions.

An audio interface may be arranged to produce and receive audio signals such as sound of a human voice. For example, an audio interface may be coupled to a speaker and microphone to enable telecommunication with other and/or generate an audio acknowledgement for some action.

A keypad may comprise any input device arranged to receive input from a user. For example, a keypad may include a push button numeric dial, or a keyboard. A keypad may also include command buttons that are associated with selecting and sending images. Optionally, a keypad may include a visual display feature integrated into a display, and/or be an application which operates as described above. Other haptic interfaces may be employed to vibrate a device in a particular way when another user of a computing device is calling, an image is received, or for use with any other functionally necessary feature as required.

An optional GPS transceiver can determine the physical coordinates of a device 100 on the surface of the Earth, which typically outputs a location as latitude and longitude values. A GPS transceiver can also employ other geo-positioning mechanisms, including, but not limited to, triangulation, assisted GPS (AGPS), E-OTD, CI, SAT, ETA, BSS or the like, to further determine the physical location of a device on the surface of the Earth. It is understood that under different conditions, a GPS transceiver can determine a physical location within millimeters of a device; and in other cases, the determined physical location may be less precise, such as within a meter or significantly greater distances. In one embodiment, however, mobile device may, through other components, provide other information that may be employed to determine a physical location of the device, including for example, a MAC address, IP address, or the like.

As illustrated in FIG. 1, image data and an audio data capture and processing device 100 comprises a transceiver 120, a camera module 140, a camera module sensor 160, and an indicator unit 180. Transceiver 120 is as described above, and, can be configured to send and receive image data and audio data over a network.

Camera module 140 can be configured to capture and process the image data and the audio data, individually or in combination. All functions of camera module 140 are connected in series and/or parallel with ground 196 to limit any and/or all electrical signal transmission to a user who operates camera module 140.

Commonly, a camera feature uses a lens 142 or series of lenses to focuses light onto a sensor, such as image capture module 144. Image capture module 144 can then, for example, record the image electronically and transfers it to a processor 150 where it can be organized, converted into binary digital data, and then stored in any of a number of storage media, for example, memory 110 or any other fixed or removable memory. This image stream may be viewed on device 100, at a remote location, on another device, or the like.

Lens 142 can be any configuration which is functionally compatible with device 100. For example, lens 142 can be, but is not limited to, a digital-zoom lens, a fixed-zoom lens, a replaceable lens system(s), and/or a fixed-focus lens. Fixed lenses, both zoom and fixed focus, in one example, tend to be found in cheaper manufactured camera module. Optical zoom lenses can have both wide angle and telephoto options. Digital zoom lenses take pixels from the central part of the image and enlarge them.

Generally, image capture module 144 can be any form of sensor, for example, a photodiode, a charge-coupled device (CCD), a complementary metal oxide semiconductor (CMOS), or the like. These sensors generally convert light into electrical charges, which are then read by processor 150 and transferred to the relevant storage media.

Commonly, sensors filter the light into the three primary colors, which can be combined to create the full spectrum. The more expensive (and higher quality) camera modules use three separate sensors to accomplish this task. Each sensor may be fitted with a filter of a different color, making it read only the light that matches that color.

Resolution also plays a role in the quality and size image data streams and signals. For example, where a camera module 140 is integrated in as a cell phone camera or other low quality camera, for example, with under a two megapixel resolution, will produce images that are really only good for emailing or web pages, not printing.

As also illustrated in FIG. 1, camera module 140 further comprises an audio capture module 148 and microphone 146. In one example, audio capture module 148 can be a transducer, which can be defined as a device that converts a signal in one form of energy to another form of energy. Energy types include, but are not limited to, electrical, mechanical, electromagnetic, chemical, acoustic and thermal energy. While the term transducer commonly implies the use of a sensor/detector, any device which converts energy can be considered a transducer. As described herein with reference to FIG. 1, audio capture module 148 converts acoustic energy to an electrical signal, in a similar fashion as described above with reference to image capture module 144.

As illustrated in FIG. 1, microphone 146 can be an acoustic-to-electric transducer or sensor that converts sound in air into an electrical signal. However, as further contemplated by the illustration in FIG. 1, microphone 146 can also encompass a speaker function, where by electrical signal may be transformed by audio capture module 148 to acoustic energy and transmitted out from device 100 to the external environment. Commonly, microphones, such as microphone 146, use electromagnetic induction, capacitance change, piezoelectricity, or some combination thereof, to produce an electrical signal from air pressure variations. Microphone 146 may optionally include a preamplifier, where the signal can be amplified within the device 100 with an audio power amplifier or recorded.

As further contemplated for use of camera module 140, is for the reception and transmission of some combination of audio-video signals by users at different locations, for communication between people in real-time. Therefore, it is contemplated that processor 150 modulate and interpret signals to determine either audio and image signal streams, in conjunction with lens 142 and microphone 146.

As illustrated in FIG. 1, camera module sensor 160 can be configured to identify a use operation of capturing image data and the audio data. Camera module sensor 160, may operate to determine usage of the camera module 140 by sensing whether or not any and or all of signal communication switches 130, 132, 134 are open or closed. In one example, where signal communication switch in 132 is closed and signal communication to camera module switch 134 is closed, a determination by camera module sensor 160 would be that a use operation exists, i.e., that camera module 140 is in use. In a second example, where signal communication switch 132 is open and signal communication to camera module switch 134 is closed, a determination by camera module sensor 160 would be that a use operation does not exist, i.e., that camera module 140 is not in use. In a third example, where signal communication switch 132 is open and signal communication to camera module switch 134 is open, a use operation does not exist, i.e., that camera module 140 is not in use. Further exemplary determinations are further contemplated, and these examples are provided for illustrative purposes only.

Camera module sensor 160 is illustrated in FIG. 1 as being in series with signal communication in switch 132 and signal communication to camera module 134, however, any functionally compatible circuit configuration is contemplated. For example, sensor 160 may be connected to switches 132, 134, in parallel, via a bridge, via a relay, through a gate or some other reasonably ascertainable configuration thereof. It should be noted that the illustrative examples of decisions made in camera module sensor 160 would need be altered so as to correspond to the connection method between sensor 160 and switches 132 and 134.

Switches 132, 134, as illustrated in FIG. 1, in one exemplary aspect because of the wiring configuration with camera module sensor 160 cannot be altered, functionally or virtually, via a malicious or security invasive software. For example, where camera module 140 is in operation by a user, said switches 132, 134 are closed, and as an incident of switches 132, 134 being closed, light emitting module 182 of light indicator unit 180 is illuminated. Illumination of light emitting module 182 does not occur if and/or unless switches 132, 134 are closed. An exemplary purpose of this configuration is to create what may commonly be referred to as a “hack-proof” functionality of camera module 140.

FIG. 1 further illustrates indicator unit 180 which has ground 198, so as to limit any electrical signal interaction with a user when indicator unit 180 is in use. Indicator unit 180 further comprises a light emitting module 182. Light emitting module 182 may comprise any light source that is functionally compatible with device 100. For example, light emitting module 182 can include, but is not limited to, a bulb such as an electric arc, in cathode ray, an incandescent bulb, carbon button lamp. Halogen bulb, a globar bulb, a light-emitting diode, a light-emitting electrochemical cell, an electroluminescent sheet or wire, or the like. Also, indicator unit 180 is contemplated, in additional embodiments, to being also a flash mechanism which works as an element of camera module 140.

As is illustrated in FIG. 1, indicator unit 180 is shown in series with camera module sensor 160. Therefore, when camera module sensor 160 makes a decision to determine a use function, light emitting module 182 may or may not be operational as a feature of camera module 140. For example, if signal communication in switch 132 is open and signal communication to camera module switch 134 is open, a use function is not detected, i.e., camera module 140 is not in use and light emitting module 182 is not illuminated. In a second example, if signal communication in switch 132 is open and signal communication to camera module switch 134 is closed, a use function is not detected, i.e., camera module 140 is not in use and light emitting module 182 is not illuminated. In a third example, if signal communication in switch 132 is closed and signal communication to camera module switch 134 is closed, a use function is detected, i.e., camera module 140 is in use and light emitting module 182 is illuminated.

Light indicator unit 180 is illustrated in FIG. 1 as being in series with camera sensor module 160, however, any functionally compatible circuit configuration is contemplated. For example, unit 180 may be connected to sensor 160 in parallel, via a bridge, via a relay, through a gate or some other reasonably ascertainable configuration thereof. It should be noted that the illustrative examples of decisions made in camera module sensor 160 as described in the previous paragraph would need be altered so as to correspond to the connection method between unit 180 and sensor 160.

Light indicator unit 180 is further connected in series with signal communication out switch 130. Communication signals provided through signal communication out switch 130, generally, would originate from outside of device 100, i.e., through a communication signal being transmitted to device 100 via transceiver 120. These signals may include incoming calls, incoming videotelephony and the like. Generally, the purpose of said switch 134 is to allow activation of light indicator unit 180 where a signal is being transmitted to device 100, not where a signal is being transmitted out of device 100. Such purpose is to limit surveillance and hacking of camera module 140 of device 100.

Countersurveillance generally refers to measures undertaken to prevent surveillance, including covert surveillance. Countersurveillance may include electronic methods such as bug sweeping, the process of detecting surveillance devices, including covert listening devices, visual surveillance devices as well as countersurveillance software to thwart unwanted attempts by cyber crooks to access computing and mobile devices for various nefarious reasons (e.g. theft of financial, personal, corporate data and to remotely view information through a user camera device). More often than not, countersurveillance will employ a set of actions (countermeasures) that, when followed, reduce the risk of surveillance. Countersurveillance should not be confused with sousveillance (inverse surveillance) as the latter does not necessarily aim to prevent or reduce surveillance. Amidst concerns over privacy, software countermeasures have emerged to prevent cyber-intrusion, the un-authorized act of spying, snooping, and stealing personally identifiable information or other proprietary assets (e.g. images) through cyberspace, however many of these methods in and of themselves may be vulnerable and susceptible to hacking and surveillance. The most common devices which can be a vulnerable target for surveillance include, but are not limited, to mobile electronic devices, laptop computers, and desk top computers.

Indicator unit 180 is, therefore, connected directly in series with signal communication out switch 130, so that when any communication signal is received by transceiver 120, and once passing through device 100 features such as applications 120 and operated upon those executable instructions contained within applications 120 by processor 106, that light emitting module 182 is illuminated regardless of camera module 140 being in use. These executable instructions shall be discussed in more detail below in reference to FIG. 5.

As illustrated in FIG. 1, in one exemplary aspect, because of the wiring configuration directly to memory 102 and the other functionally necessary modules of device 100, switch 130 cannot be altered, functionally or virtually, via a malicious or security invasive software. For example, where camera module 140 is not in operation by a user and switches 132, 134 are open, but communication signals are being transmitted to camera module 140 via switch 130 being closed, light emitting module 182 of light indicator unit 180 is illuminated. In this illustration, illumination of light emitting module 182 does not occur if and/or unless switch 130 is closed. An exemplary purpose of this configuration is to create what may commonly be referred to as a “hack-proof” functionality of camera module 140.

FIG. 1 illustrates only one embodiment of the present inventive concept. Additional embodiments are further contemplated, with additional and/or exemplary aspects of each element as described above, one or more of which can be combined with the basic invention as embodied above. The camera module can be configured to further include a photodiode to convert received light into said image data and a transducer to convert received sound into said audio data. The processor of the camera module sensor can contain computer executable instructions, which cause the camera module sensor to authenticate image data and audio data sent and received via the transceiver to determine if a privacy invasive software is simulating an authenticated user of the image data and audio data processing device and retrieving said image data and said audio data and cause the camera module sensor to flag for notification the privacy invasive software and transmitting the notification to the authenticated user of the image data and audio data processing device. The light emitting module of the indicator unit can be configured to include a light emitting diode; and the light emitting module of the indicator unit can be configured to further comprise a first emitting element which is activated by the camera module sensor when the use operation of the camera module is identified and can be configured to further comprise a second light emitting element which is activated by the camera module sensor when a privacy invasive software is simulating an authenticated user of the image data and audio data processing device and retrieving said image data and said audio data.

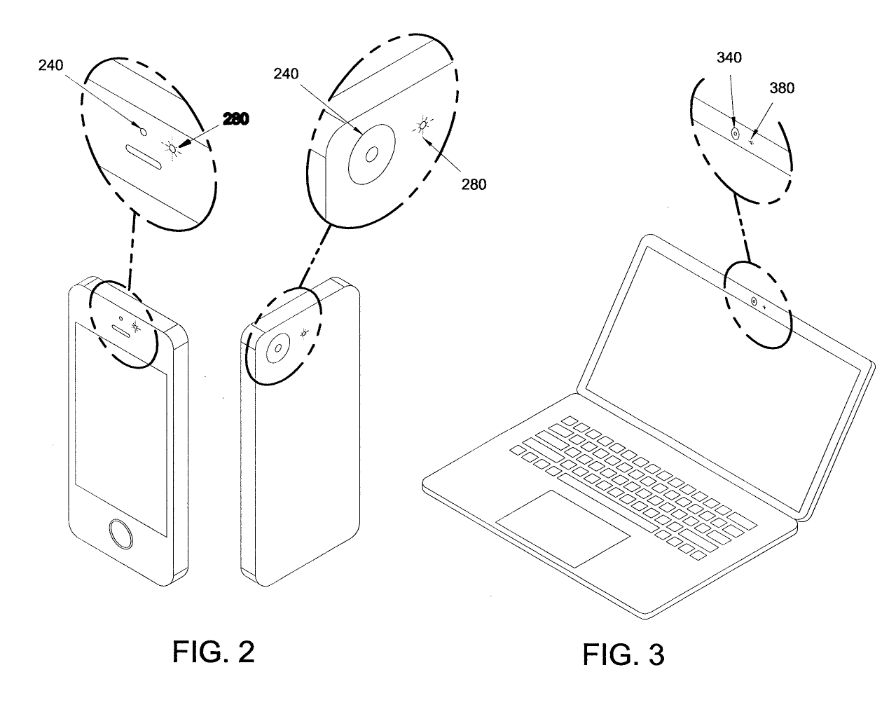

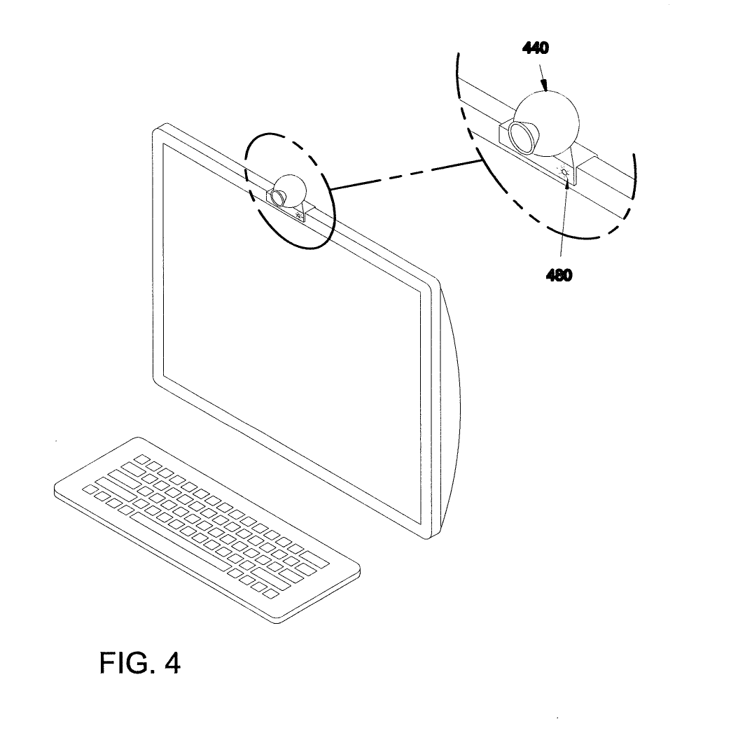

FIGS. 2-4 illustrate exemplary embodiments of the present inventive concept, embodied in three exemplary image capture and data capture computing devices. For example, FIG. 2 illustrates the inventive concept embodied in a camera module 240 integrated into a mobile communication device 200. FIG. 3 illustrates the inventive concept embodied in a camera module 340 integrated into a laptop computing device 300. FIG. 4 illustrates the inventive concept embodied in an external webcam 440 module attached to a desktop computing device 400.

In general, an image data and audio data capture device as described herein, especially with reference to FIGS. 2-4, comprise a computer-operated image data and audio data capture and/or retrieving device. These devices generally include, but are not limited to the following elements a transceiver, a processor, a camera module, a camera module sensor, and an indicator unit. Additional computing components, modules, add-on, integrations and the like are further considered, however, are not further described herein.

As discussed above, the transceiver can be configured to send and receive image data and audio data over a network, and the processor can be configured to process image data and audio data. Furthermore, the camera module can be configured to capture and process the image data and the audio data, individually or in combination, when an authenticated user activates the camera module.

In FIG. 2, mobile communication device 200 typifies a classification of devices commonly known as mobile devices, which are additionally known as handheld computers or simply handhelds. These devices can be defined as a small, handheld computing device, typically having a display screen with touch input and/or a miniature keyboard and weighing less than 2 pounds (0.91 kg).

Devices such as mobile communication device 200 generally comprise an operating system (OS), and can run various types of application software, commonly known in the industry “apps.” Furthermore, mobile communication devices 200 can also be equipped with network communication capabilities, such as Wi-Fi, Bluetooth, and UPS capabilities that can allow connections to the Internet, other devices, and the like.

As is illustrated in FIG. 2, mobile communication device 200 can include a number of interchangeable components which offer various features of functionality and performance based on the preferences of a user. Such interchangeable components shall not be discussed further herein, but any and all known and reasonably ascertainable components are contemplated for use with mobile communication device 200 typified herein and also in conjunction with or independently from the inventive concept provided for in this detailed description.

Mobile communication device 200, as illustrated, comprises camera module 240 and indicator unit 280. Camera module 240 and indicator unit 280 can be integrated into communication device 200 as discussed above, with reference to FIG. 1, and using any known or reasonably ascertainable manufacturing and/or fabricating method which is functionally necessary to create a mobile communication device 200 which serves at least one purpose for which a user would operate a communication device.

Further as illustrated in FIG. 2, communication device 200 can optionally have at least one or more than one camera module 240 and/or indicator unit 280. In one common example, as illustrated in FIG. 2, a communication device 200 may have a front-facing camera module 240 and indicator unit 280 and/or a back-facing camera module 240 and indicator unit 280. In FIG. 2, these elements are illustrated as being similar in location and intrinsic components, however, it is contemplated that camera module 240 and indicator unit 280 may be located anywhere on communication device 200, have any reasonably functional configuration, and where there is one or more of each said element, the elements may be the same, similar, and/or different as is functionally necessary for the operation of the individual components, operation of the components together, and/or operation of mobile communication device 200.

In FIG. 3, a laptop computing device 300 is illustrated with a camera module 340 and an indicator unit 380 integrated into a frame of a viewing element 302 of the device 300. Laptop computing device 300 typifies a classification of portable personal computing devices which commonly have a clamshell form factor, suitable for mobile use. These devices may sometimes be called notebook computers or notebooks. Laptop computing devices are commonly used in a variety of settings, including work, education, and personal multimedia.

A laptop computing device generally includes many of the components and inputs of a desktop computer device (described below in more detail with reference to FIG. 4), including but not limited to a display, speakers, a keyboard, and pointing device (such as a touchpad), into a single device. Commonly, laptop computing devices have a camera module 240 and a microphone pre-installed. Devices such as laptop computing device 300 commonly differ from traditional desktop computing devices in that the device can be powered either from a rechargeable battery, or by electricity via an adapter. Hardware specifications change vastly between devices dependent on the preferences of a user.

Portable computers were originally monochrome CRT-based and developed into the modern laptops, were originally considered to be a small niche market, mostly for specialized field applications such as the military, accountants and sales representatives. As portable computers became smaller, lighter, cheaper, and more powerful and as screens became smaller and of better quality, laptops became very widely used for a variety of purposes. One common purpose, for use of laptop computing device 300 is internet connection in a personal home, in a work environment, outside, or any other environment where mobile computing is desired by a user.

In one example, where laptop computing device 300 is in use in a personal home, multiple users may have access to a single device, commonly browsing the web and making known and unknown social connections through various social media platforms, in one example, engaging in ecommerce in another example. In general, the majority of uses for which a laptop computing device is accessed on a regular basis by a user provide numerous opportunities for the integration of privacy invasive software into the memory, operating system or other functionally necessary components of the device.

Therefore, as described above with more detail below with reference to FIG. 5, camera module 340 can have one or elements which can be configured to be in communication with the operating system or other components of laptop computing device 300 to identify a use operation of the device 300, and can also be configured to execute computer executable instructions to authenticate image data and/or audio data sent and received by device 300, to determine if a privacy invasive software is simulating an authenticated user of device 300 and potentially recovering any image data or audio data being created by a user or captured intentionally and/or unintentionally as a function of camera module 340. The privacy invasive software may be flagged for notification, and optionally the notification can be transmitted to the authenticated user of device 300.

In additional embodiments of laptop computing device 300 as contemplated herein, camera module 340 can optionally be configured to identify the use operation and cause a processor integrated into the camera module, an external processor, or a processor otherwise integrated into the laptop computing device 300 to execute the computer readable instruction process described above and activate indicator unit 380, illuminating a light emitting module contained therein (not shown). This light emitting module may comprise any light emitting element, for example, but not in limitation, an incandescent light bulb, a light emitting diode, a capacitative light element, or any other known or reasonably ascertainable light projecting configuration.

FIG. 4 illustrates a desktop computing device 400, a webcam 402 which further includes camera module 440 and indicator unit 480, a monitor 404, and a keyboard 406. Webcam 402 can generally be defined as an image capture device typified as a video camera that feeds or streams its image in real time to or through a computing device to a network. When “captured” by camera module 440, the video stream may be saved, viewed or sent on to other networks via systems such as the internet, and/or emailed as an attachment. In one common example, when the data stream is sent to a remote location, the video stream may be saved, viewed or sent to another location from there. Unlike an IP camera (which connects using Ethernet or Wi-Fi), a webcam is generally connected by a USB cable, or similar cable, or built into computer hardware, such as desktop or laptop computing devices.

Webcam 402's most common use is the establishment of video links, permitting computers to act as videophones or videoconference stations. Other common uses include security surveillance, computer vision, video broadcasting, and for recording social videos. Webcams are known for their low manufacturing cost and flexibility, making them the lowest cost form of videotelephony. They have also become a source of security and privacy issues, as some built-in webcams can be remotely activated via spy ware and other privacy invasive software as described herein.

The exemplary embodiments as illustrated in FIGS. 2-4 may further have additional optional elements and components, and the elements and modules described above can be furthered configured to include additional contemplated elements. For example, the camera module 240, 340, 440 may be configured to include at least one photodiode to convert received light into image data and/or at least one transducer to convert received sound into audio data. In one optional example, a light emitting module of indicator unit 280, 380, 480 can be configured to include at least one light emitting diode and/or a first light emitting element, which can be activated by the camera module sensor (not shown) when a use operation of the camera module 240, 340, 440. Additionally, the indicator unit 280, 380, 480 can also be configured to further include a second light emitting element, which can be activated by the camera module sensor (not shown) when a privacy invasive software is simulating an authenticated user of the device 200, 300, 400 and retrieving any and/or all image and audio data.

FIG. 5 illustrates a non-transitory computer readable storage medium 500 which can contain computer readable instructions 502 which operate an exemplary image data and audio data capture and processing device, as typified above with reference to FIGS. 1-5.

In computing, generally, a machine-readable medium 500, which may also be known as automated data medium, can be defined as a medium capable of storing data in a format readable by a mechanical device (i.e., rather than human readable). Examples of machine-readable media include magnetic media such as integrated memory, portable memory such as flash drives, memory sticks, magnetic disks, cards, tapes, and drums, punched cards and paper tapes, optical disks, barcodes and magnetic ink characters. Additional machine-readable technologies include magnetic recording, processing waveforms, and barcodes. Optical character recognition (OCR) can be used to enable machines to read information available to humans. Any information retrievable by any form of energy can be construed as machine-readable.

Computer executable instructions can be executed within a computing device, using any reasonably known or knowable device elements, for example, a processor microprocessor or the like, and can enable the computing device to complete one, one or more, any, all or none of the instructions provided for below. The processing and operating elements of the exemplary computing device(s) upon which these instructions are operable are not described herein with reference to FIG. 5, as these devices are described more fully above with reference to FIGS. 1-5.

In no particular order, the computer executable instructions can be performed herein as listed below, however it is contemplated the instructions can be performed in any order reasonably necessary to provide the functionality required by a user of the computing device. Furthermore, it should be noted, that each instruction described herein need not be completed for the invention concept to be fully realized.

The instructions contemplated herein include detection of a data stream 502 being provided to a camera module of the computing device by a user. The data stream can be an image stream, for example, still photos, a live action photo, or a video, or any combination thereof. The data stream can also be, for example, an audio stream, including but not limited to, sound, speech, music, or other audio signal. Furthermore, the stream can be a combination of images and/or audio.

A next instruction can include authentication of the user providing the data stream 504 to the camera module of the computing device. Authentication of user and/or their devices can occur through various methods and embodiments as contemplated to be used alone, in conjunction or integrated into the system, methods, and processes which are part of the inventive concept.

Authentication can be defined as the act of confirming the truth of an attribute of a datum or entity. This might involve confirming the identity of a person or software program, tracing the origins of an artifact, or ensuring that a product is what its packaging and labeling claims to be. Authentication often involves verifying the validity of at least one form of identification.

Generally, a secure key storage device can be used for authentication in consumer electronics, network authentication, license management, supply chain management, and any other system or process that requires an authentication element. Commonly, for example, the device to be authenticated can have some sort of wireless or wired digital connection to either a host system or a network. The component being authenticated need not be electronic in nature as an authentication chip can be mechanically attached and read through a connector to the host e.g. an authenticated ink tank for use with a printer. For products and services that these secure coprocessors can be applied to, they can offer a solution that can be much more difficult to counterfeit than most other options while at the same time being more easily verified.

The process of authorization is distinct from that of authentication. Whereas authentication is the process of verifying that “you are who you say you are”, authorization is the process of verifying that “you are permitted to do what you are trying to do”. Authorization thus presupposes authentication. For example, a client showing proper identification credentials to a bank teller is asking to be authenticated that he really is the one whose identification he is showing. A client whose authentication request is approved becomes authorized to access the accounts of that account holder, but no others. However note that if a stranger tries to access someone else's account with his own identification credentials, the stranger's identification credentials will still be successfully authenticated because they are genuine and not counterfeit, however the stranger will not be successfully authorized to access the account, as the stranger's identification credentials had not been previously set to be eligible to access the account, even if valid (i.e. authentic).

Similarly when someone tries to log on a computer, they are usually first requested to identify themselves with a login name and support that with a password. Afterwards, this combination is checked against an existing login-password validity record to check if the combination is authentic. If so, the user becomes authenticated (i.e. the identification he supplied in step 1 is valid, or authentic). Finally, a set of pre-defined permissions and restrictions for that particular login name is assigned to this user, which completes the final step, authorization. Even though authorization cannot occur without authentication, the former term is sometimes used to mean the combination of both.

One exemplary use of authentication and authorization is access control. Additionally, authentication and authorization are used interchangeably in the context of computing. In one embodiment of the present process, a user device is contemplated to be used only by those authorized, and attempts to detect and exclude the unauthorized are considered. Access to a user device should then, generally, be controlled by insisting on an authentication procedure to establish with some degree of confidence the identity of the user, granting privileges established for that identity. Further exemplary examples of access control involving authentication include, but are not limited to, using a captcha or other recognition software application as a means of asserting that a user is a human being and not a computer program, by using One Time Password (OTP), received on a tele-network enabled device like mobile phone, as an authentication password/PIN, A computer program using a blind credential to authenticate to another program, and/or using a confirmation E-mail to verify ownership of an e-mail address.

A next instruction may include monitoring of a transceiving channel of the computing device 508, to determine if a privacy invasive software is simulating an authenticated user of the camera module via a remote network device and removing to a remote network device any, all, a part or none of the data stream.

Packet capture, which can also sometimes be referred to as “packet sniffing,” the monitoring of data traffic on a computing device and/or network. Computers communicate over the Internet by breaking up messages (emails, images, videos, web pages, files, etc) into small chunks called “packets”, which are routed through a network of computers, until they reach their destination, where they are assembled back into a complete “message” again. IN one example, a capture module (not shown) has the capability to intercept these packets as they are travelling through the connections on a device and over a network, in order to examine their contents using other programs. A packet capture is an information gathering tool, but not an analysts tool. That is it gathers “messages” but it does not analyze them and figure out what they mean. Other programs are needed to perform traffic analysis and sift through intercepted data looking for important/useful information, Under the Communications Assistance For Law Enforcement Act all U.S. telecommunications providers are required to install packet sniffing technology to allow Federal law enforcement and intelligence agencies to intercept all of their customers' broadband Internet and voice over Internet protocol (VoIP) traffic.

Additional methods of monitoring are also contemplated, for example, it is possible to monitor computing devices and networks from a distance by detecting the radiation emitted by the devices. These methods may involve reading electromagnetic emanations from computing devices in order to extract data from them at distances of hundreds of meters. Other methods may include, monitoring the slightly different noises emitted by keyboard keys when pressed. The differences are individually identifiable under some conditions, and so it's possible to log key strokes without actually requiring logging software to run on the associated computer. Other methods may also include analyzing the high frequency noise emitted by a CPU for information about the instructions being executed.

Another instruction may include flagging for notification the privacy invasive software 510. In computer programming, lint was the name originally given to a particular program that flagged some suspicious and non-portable constructs (likely to be bugs) in C language source code. The term is now applied generically to tools that flag suspicious usage in software written in any computer language. The term lint-like behavior is sometimes applied to the process of flagging suspicious language usage. Lint-like tools generally perform static analysis of source code. Furthermore, lint as a term can also be defined to refer more broadly to syntactic discrepancies in general, especially in interpreted languages like JavaScript and Python. For example, modern lint checkers are often used to find code that doesn't correspond to certain style guidelines. They can also be used as simple debuggers for common errors, or hard to find errors such as heisenbugs.

In one example, suspicious constructs can include but are not limited to, variables being used before being set, division by zero, conditions that are constant, and calculations whose result is likely to be outside the range of values representable in the type used. Many of the forms of analysis performed by lint-like tools are also performed by optimizing compilers, whose prime motivation is to generate faster code. Modern compilers can often detect many of the constructs traditionally warned about by lint. Modern tools perform forms of analysis that many optimizing compilers typically do not do, such as cross-module consistency checking, checking that the code will be portable to other compilers, and supporting annotations that specify intended behavior or properties of code.

Yet still another instruction includes transmission of the notification to the authenticated user 512. Transmission of the notification can occur through a number of various methods, including but not limited to, a phone call, a text message, an email, or the like. In one example, where the device in use is used by a minor, or someone under the age of eighteen or otherwise supervised persons of any age, the transmission of the notification may not go directly to the user, but to an authorized party such as a parent, a teacher, a probation officer, or a corrections officer. Transmission methods may also vary in the format and content of the transmission, for example, over a wireless or wired network, via near radio frequency communication (NFC) or radio frequency (RFID) technologies, and/or via Bluetooth or other networks.

A last instruction may include activation of an indicator unit 514. This activation can optionally include a visual display, a physical activation, a digital display, a virtual activation, an image display, an audio display, or any other activation method can reasonably be accomplished within a computing device using any and all known and reasonably ascertainable activation methods.

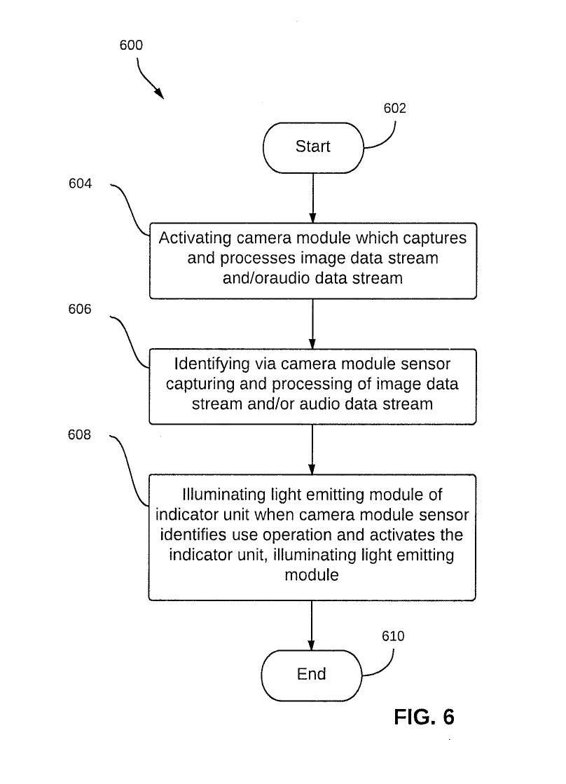

FIG. 6 illustrates a logical flow diagram generally showing one method of using and/or operating any of the embodiments as described above of the inventive concept.

An exemplary method 600 of using and/or operating any of the above-described device embodiments is further provided. It should be noted that the method provided for below and illustrated in FIG. 6 includes a number of method steps which can executed in the order as provided, randomly, or in any order as determined by a user implementing the method. Furthermore, each step of the method can be interchangeable with one another and need not be completed for the invention concept to be fully realized.

The method 600 starts at 602 and thereafter continues at 604 where a user activates the camera module which captures and processes a data stream. The data stream, as described above, may be an audio stream or an image stream. The data stream may also be an audio stream and a data stream. Further embodiments contemplated where the data stream is some combination thereof of an audio and/or data stream. Examples of the data stream can include, but are not limited to, still photos, video, a phone call, a VoIP communication, or the like.

At 606, a camera module sensor identifies the capturing and processing of the image data stream and the audio data stream, i.e, the camera module sensor identifies when the camera module is in use. Identification of use by the camera module sensor may include, for example, conversion of image data and/or audio data to an electric signal. Review and quantification of this signal is one optional method of determination by a processing device whether or not the camera module is in use. Further methods of identification are also contemplated. For example, the camera module sensor may be a photodiode and/or transducer to convert received light and/or sound to a known electrical signal for review. Additional methods are further contemplated.

Lastly, at 608 a light emitting module contained within an indicator unit is illuminated when the camera module sensor identifies the use operation and activates the indicator unit. The method thereafter ends at 610.

A number of exemplary aspects can be included into, excluded from, used in conjunction with or independently from the exemplary method as described above. These exemplary aspects may include, but are not limited to, the camera module can be configured to include at least one photodiode to convert received light into image data, and at least one transducer to convert received sound into audio data. Optionally, the camera module sensor can be configured to include computer executable instructions, which may cause the camera module sensor to authenticate a stream to determine if privacy invasive software is simulating an authenticated user for the device, and/or removing, retrieving or storing any or all of the data stream. Additionally, the camera module sensor can be configured to further comprise computer executable instructions, which cause the camera module sensor to flag for notification the privacy invasive software and transmitting that notification to the authenticated user

Additional optional exemplary aspects which may be combined with the method as described above can include the light emitting module of the indicator unit configured to have a first emitting element, which can be activated by the camera module sensor when the use operation of the camera module is identified, and/or a second light emitting element, which can be activated by the camera module sensor when a privacy invasive software is simulating an authenticated user device and otherwise removing, retrieving or storing any or all of the data stream. Also, the light emitting module of the indicator unit can be configured to include at least one light emitting diode.

Additional methods, aspects and elements of the present inventive concept are contemplated in use in conjunction with individually or in any combination thereof which will create a reasonably functional method, system and device to be of use as data processing device with a light indicator unit. Methods of use are also contemplated using all optional aspects and embodiments as described above, individually or in combination thereof.

It will be apparent to one of ordinary skill in the art that the manner of making and using the claimed invention has been adequately disclosed in the above-written description of the exemplary embodiments and aspects. It should be understood, however, that the invention is not necessarily limited to the specific embodiments, aspects, arrangement and components shown and described above, but may be susceptible to numerous variations within the scope of the invention.

Moreover, particular exemplary features described herein in conjunction with specific embodiments and/or aspects of the present invention are to be construed as applicable to any embodiment described within, enabled thereby, or apparent wherefrom. Thus, the specification and drawings are to be regarded in a broad, illustrative, and enabling sense, rather than a restrictive one.

Further, it will be understood that the above description of the embodiments of the present invention are susceptible to various modifications, changes, and adaptations, and the same are intended to be comprehended within the meaning and range of equivalents of the appended claims.

What I claim, is:

1. An image data and an audio data capture and processing device, comprising:
a transceiver to send and receive image data and audio data over a network;
a camera module which captures and processes said image data and said audio data individually or in combination when a user activates the camera module;
a camera module sensor which identifies a use operation of capturing said image data and said audio data; and
an indicator unit which includes a light emitting module;
wherein when the camera module is capturing and processing said image data and said audio data and the transceiver sends and receives said data over the network, the camera module sensor identifies the use operation and activates the indicator unit illuminating the light emitting module.

2. The image data and audio data processing device of claim 1, wherein the camera module further comprises at least one photodiode to convert received light into said image data.

3. The image data and audio data processing device of claim 1, wherein the camera module further comprises at least one transducer convert received sound into said audio data.

4. The image data and audio data processing device of claim 1, wherein the camera module sensor further comprises a processor and computer executable instructions when executed by said processor cause the camera module sensor to authenticate image data and audio data sent and received via the transceiver to determine if a privacy invasive software is simulating an authenticated user of the image data and audio data processing device and retrieving said image data and said audio data.

5. The image data and audio data processing device of claim 4, wherein the camera module sensor further comprises computer executable instructions when executed by said processor cause the camera module sensor to flag for notification the privacy invasive software and transmitting said notification to the authenticated user of the image data and audio data processing device.

6. The image data and audio data processing device of claim 1, wherein the light emitting module of the indicator unit further comprises at least one light emitting diode.

7. The image data and audio data processing device of claim 1, wherein the light emitting module of the indicator unit further comprises a first emitting element which is activated by the camera module sensor when the use operation of the camera module is identified and further comprises a second light emitting element which is activated when by the camera module sensor when a privacy invasive software is simulating an authenticated user of the image data and audio data processing device and retrieving said image data and said audio data.

8. A computer-operated image data and an audio data retrieving device, comprising:
a transceiver to send and receive image data and audio data over a network;
a processor;
a camera module which captures and said image data and said audio data individually or in combination when an authenticated user activates the camera module;
a camera module sensor which identifies a use operation of capturing said image data and said audio data and computer executable instructions when executed by the processor that cause the camera module sensor to:
authenticate image data and audio data sent and received via the transceiver to determine if a privacy invasive software is simulating an authenticated user of the computer-operated image data and an audio data retrieving device and recovering said image data and said audio data;
flag for notification the privacy invasive software; and
transmit said notification to the authenticated user of the computer-operated image data and an audio data retrieving device;
an indicator unit which includes a light emitting module;
wherein when the camera module is capturing said image data and said audio data and the transceiver sends and receives said data over the network, the camera module identifies said use operation and causes the processor to execute said computer readable instructions, and thereafter activates the indicator unit thereby illuminating the light emitting module.

9. The computer-operated image data and an audio data retrieving device of claim 8, wherein the camera module further comprises at least one photodiode to convert received light into said image data.

10. The computer-operated image data and an audio data retrieving device of claim 8, wherein the camera module further comprises at least one transducer convert received sound into said audio data.

11. The computer-operated image data and an audio data retrieving device of claim 8, wherein the light emitting module of the indicator unit further comprises at least one light emitting diode.

12. The computer-operated image data and an audio data retrieving device of claim 8, wherein the light emitting module of the indicator unit further comprises a first emitting element which is activated by the camera module sensor when the use operation of the camera module is identified and further comprises a second light emitting element which is activated when by the camera module sensor when a privacy invasive software is simulating an authenticated user of the image data and audio data processing device and retrieving said image data and said audio data.

13. A non-transitory computer readable storage medium having computer-executable instructions, the computer-executable instructions when installed onto a computing device enable the computing device to perform actions, comprising:
detect an image data stream or an audio data stream being provided to a camera module of the computing device by a user;
authenticate the user providing the image data stream or the audio data stream to the camera module of the computing device;
monitor a transceiving channel of the computing device, to determine if a privacy invasive software is simulating an authenticated user of the camera module via a remote network device and removing to the remote network device the image data stream and the audio data stream;
flag for notification the privacy invasive software;
transmit said notification to the authenticated user; and
activate an indicator unit which further comprise a light emitting module.

14. The non-transitory computer readable storage medium having computer-executable instructions of claim 13, the computer-executable instructions when installed onto a computing device enable the computing device to perform actions, wherein the camera module further comprises at least one photodiode to convert received light into the image data stream and at least one transducer to convert received sound into the audio data stream.

15. The non-transitory computer readable storage medium having computer-executable instructions of claim 13, the computer-executable instructions when installed onto a computing device enable the computing device to perform actions, wherein the light emitting module of the indicator unit further comprises at least one light emitting diode.

16. The non-transitory computer readable storage medium having computer-executable instructions of claim 13, the computer-executable instructions when installed onto a computing device enable the computing device to perform actions, wherein the light emitting module of the indicator unit further comprises a first emitting element which is activated by the camera module sensor when the use operation of the camera module is identified and further comprises a second light emitting element which is activated when by the camera module sensor when a privacy invasive software is simulating an authenticated user of the image data and audio data processing device and retrieving said image data and said audio data.

17. A method of using image data and an audio data processing device, comprising:
activating a camera module which captures and processes an image data stream or an audio data stream when a user initiates said activation;
identifying via a camera module sensor the capturing and processing of said image data stream and said audio data stream; and
illuminating a light emitting module of an indicator unit when the camera module sensor identifies the use operation and activates the indicator unit thereby illuminating the light emitting module.

18. The method of claim 17, wherein the camera module further comprises at least one photodiode to convert received light into said image data and at least one transducer to convert received sound into said audio data.

19. The method of claim 17, wherein the camera module sensor further comprises computer executable instructions when executed by a processor cause the camera module sensor to authenticate the image data stream and the audio data stream to determine if a privacy invasive software is simulating an authenticated user of the image data and audio data processing device and retrieving said image data stream and said audio data stream.

20. The method of claim 19, wherein the camera module sensor further comprises computer executable instructions when executed by said processor cause the camera module sensor to flag for notification the privacy invasive software and transmitting said notification to the authenticated user of the image data and audio data processing device.

21. The method of claim 17, wherein the light emitting module of the indicator unit further comprises a first emitting element which is activated by the camera module sensor when the use operation of the camera module is identified and further comprises a second light emitting element which is activated when by the camera module sensor when a privacy invasive software is simulating an authenticated user of the image data and audio data processing device and retrieving said image data and said audio data.

22. The method of claim 17, wherein the light emitting module of the indicator unit further comprises at least one light-emitting diode.
